(19) United States
(12) Patent Application Publication
(10) Pub. No.: US 2016/0243596 A1
(43) Pub. Date: Aug. 25, 2016

(54) BAG APPARATUS FOR DELIVERING FLUID

(71) Applicants: Ying-Chieh Liao, Taichung City (TW); Yu-Kuo Liao, Taichung City (TW)

(72) Inventors: Ying-Chieh Liao, Taichung City (TW); Yu-Kuo Liao, Taichung City (TW)

(21) Appl. No.: 14/626,304

(22) Filed: Feb. 19, 2015

(51) Int. Cl. B08B 9/032; E03C 1/306

(52) U.S. Cl. CPC B08B 9/0322; E03C 1/306

(57) ABSTRACT

A bag apparatus for delivering fluid comprises an inflatable bag structure, a pipe and an adjuster. The inflatable bag structure includes a first channel and a second channel. The pipe penetrates through the inflatable bag structure and includes a first conduit. The first conduit communicates with an outside of the inflatable bag structure. An inflated space is formed between the pipe and the inflatable bag structure and communicates with the first channel. The first conduit communicates with the second channel. The adjuster is movably inserted into an end of the inflatable bag structure. A through hole is disposed on the radial side of the adjuster. When the adjuster moves to an inflating position, the through hole communicates with the first channel and a fluid supply; when the adjuster moves to a delivering position, the through hole communicates with the second channel and the fluid supply.

### BACKGROUND OF THE INVENTION

1. Field of the Invention

The present invention relates to a bag apparatus, and more particularly to a bag apparatus for delivering fluid.

2. Description of the Prior Art

The bag apparatus for delivering fluid generally includes two pipes. Wherein one pipe penetrates through the bag apparatus to deliver fluid into a tube, and another pipe can deliver fluid into bag apparatus to expand it. Each pipe is provided with one valve so that the fluid supply can be selectively communicable or incommunicable with each said pipe. The prior art is disclosed in U.S. Pat. No. 4,354,515.

However, when a user wants to change the direction of the fluid, the user needs to adjust two valves. It is inconvenient for a user to use. Besides, the apparatus having two pipes occupies too much space. These disadvantages need to be solved.

The present invention has arisen to mitigate and/or obviate the afore-described disadvantages.

### SUMMARY OF THE INVENTION

The primary object of the present invention is to provide a bag apparatus for delivering fluid, having an adjuster and a pipe penetrating an inflatable bag structure. The adjuster can be adjusted to make fluid flows into inflated space or a tube. The present invention is more convenient and smaller than the prior art.

To achieve the above object, a bag apparatus for delivering fluid is provided, which is provided for delivering a fluid to a tube, comprising an inflatable bag structure, a pipe and an adjuster. The inflatable bag structure includes a first channel and a second channel. The pipe penetrates through the inflatable bag structure and includes a first conduit. The first conduit communicates with an outside of the inflatable bag structure. An inflated space is formed between the pipe and the inflatable bag structure and communicates with the first channel. The first conduit communicates with the second channel. The adjuster is movably inserted into an end of the inflatable bag structure. A through hole is disposed on the radial side of the adjuster. Wherein when the adjuster moves to an inflating position, the through hole communicates with the first channel and the fluid supply, the second channel is incommunicable with the fluid supply; when the adjuster moves to a delivering position, the through hole communicates with the second channel and a fluid supply. The first channel is incommunicable with the fluid supply.

### BRIEF DESCRIPTION OF THE DRAWINGS

FIG. 1 is a three-dimensional drawing of a preferable embodiment of the present invention;

FIG. 2 is a breakdown drawing of the preferable embodiment of the present invention;

FIG. 3 is a cross-sectional drawing taken along the line B-B in FIG. 1;

FIG. 3A is an enlarged view of a portion of FIG. 3;

FIG. 4 is a cross-sectional drawing taken along the line A-A in FIG. 1;

FIG. 4A is an enlarged view of a portion of FIG. 4; and

FIG. 5 is a perspective drawing of the preferable embodiment of the present invention in operation.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

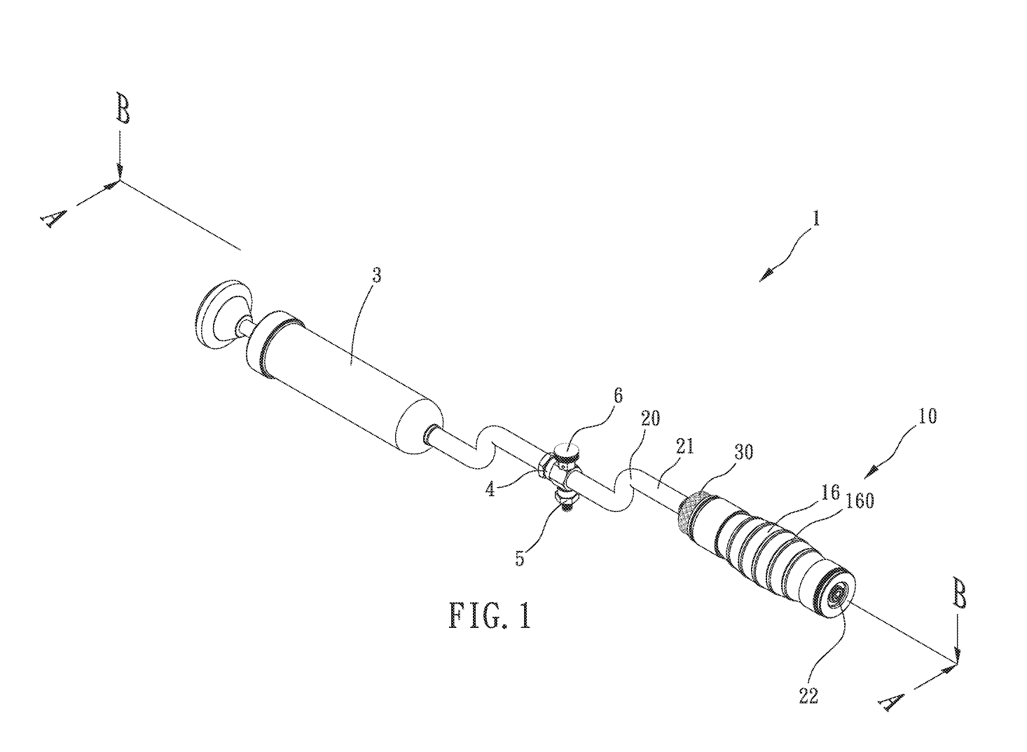

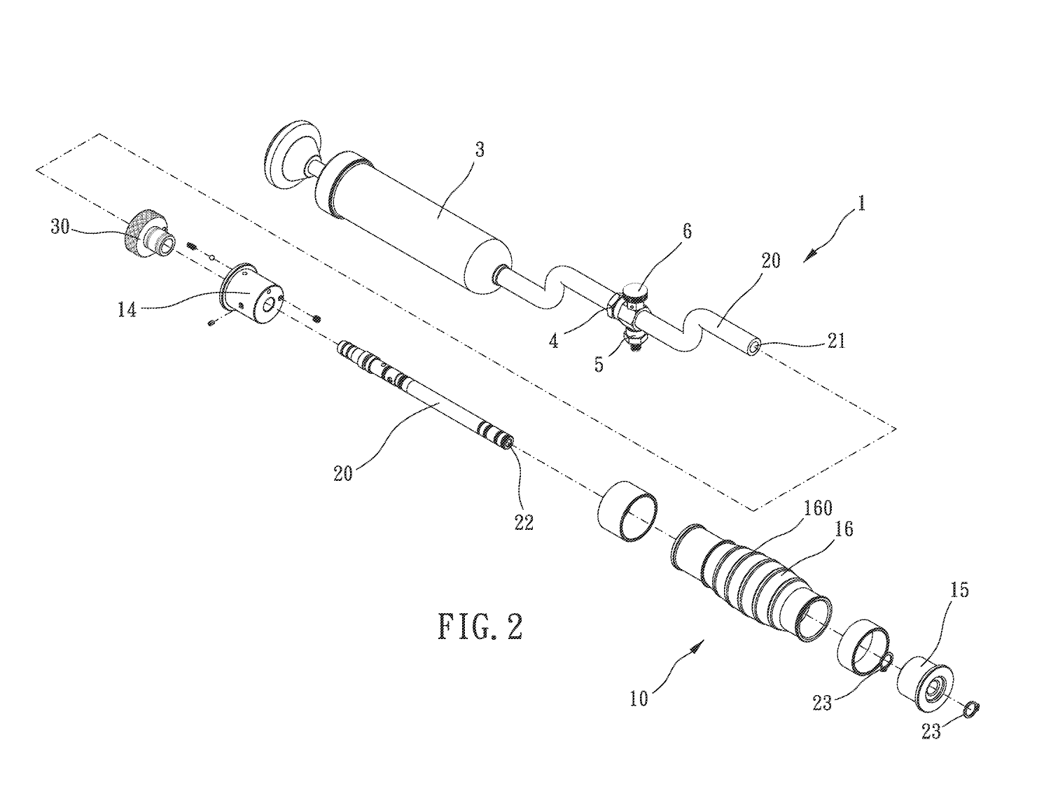

Referring to FIGS. 1, 2, 3, 3A, 4, 4A and 5, a bag apparatus for delivering fluid 1 in accordance with a preferred embodiment of the present invention is provided. The bag apparatus for delivering fluid 1 is provided for delivering a fluid to a tube 2 and comprises an inflatable bag structure 10, a pipe 20 and an adjuster 30.

The inflatable bag structure 10 includes a first channel 11 and a second channel 12.

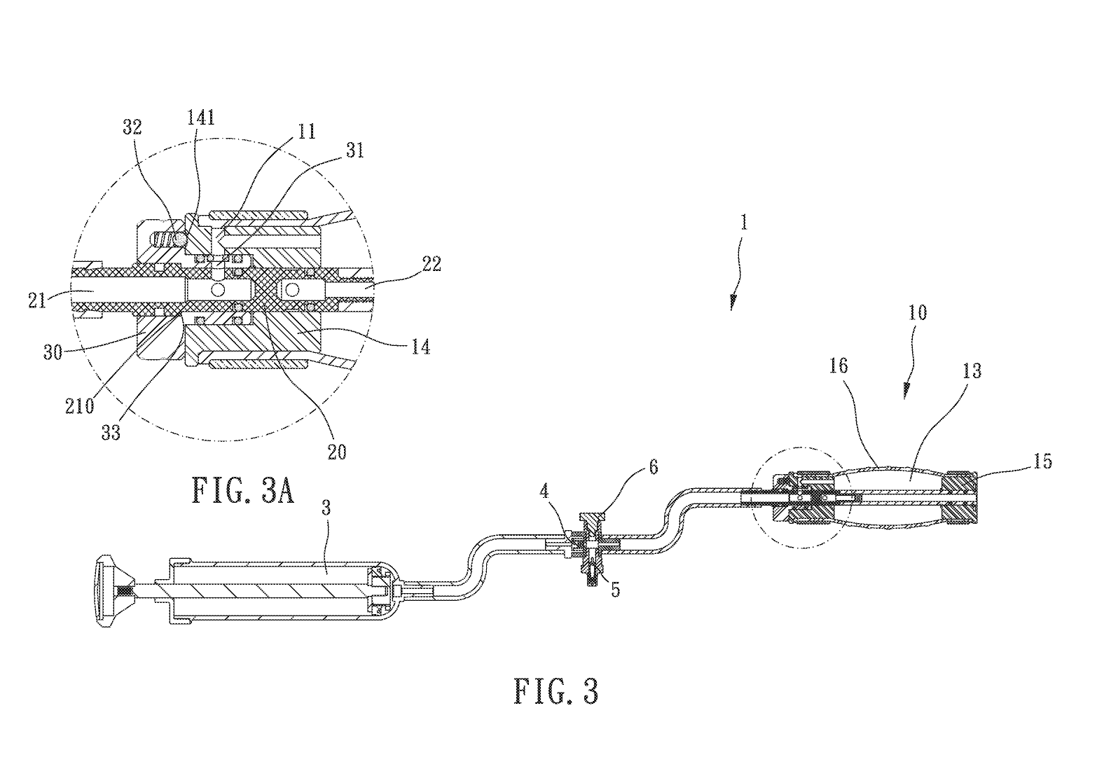

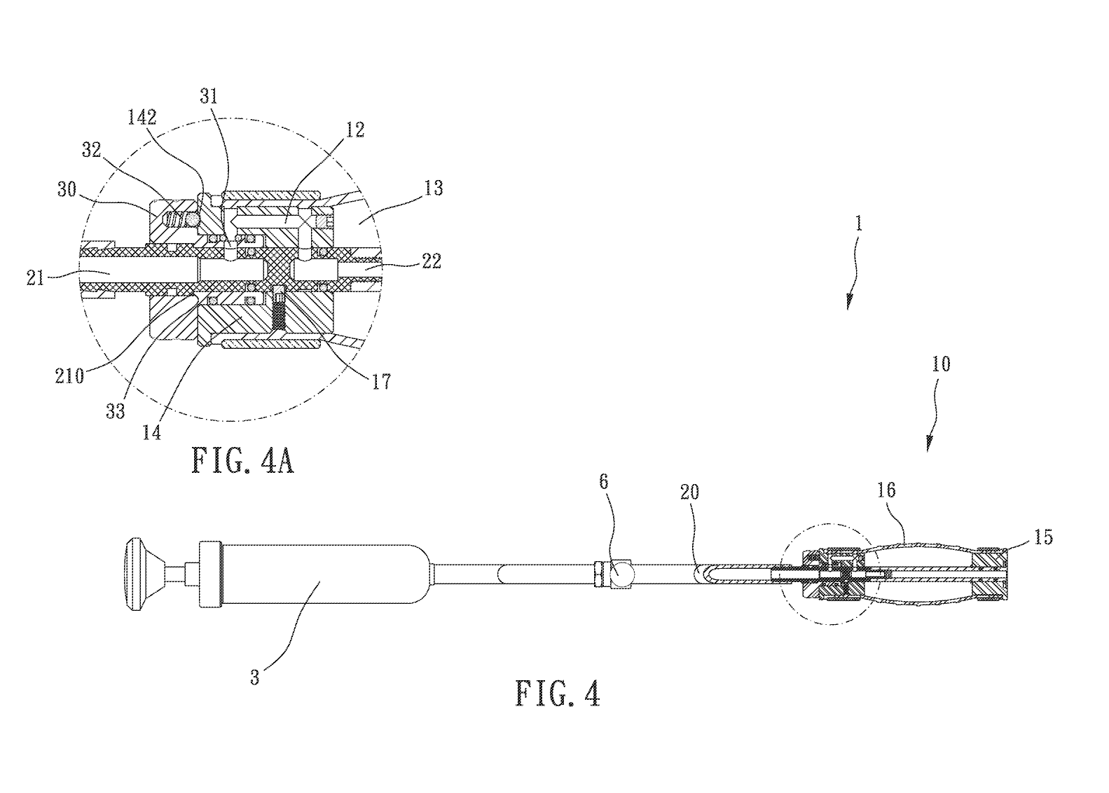

The pipe 20 penetrates through the inflatable bag structure 10 and includes a first conduit 22. The first conduit 22 communicates with an outside of the inflatable bag structure 10. An inflated space 13 is formed between the pipe 20 and the inflatable bag structure 10 and communicates with the first channel 11 (FIG. 3A). The first conduit 22 communicates with the second channel 12 (FIG. 4A).

The adjuster 30 is movably inserted into an end of the inflatable bag structure 10. A through hole 31 is disposed on the radial side of the adjuster 30. Wherein when the adjuster 30 moves to an inflating position, the through hole 31 communicates with the first channel 11 and the fluid supply 3, and the second channel 12 is incommunicable with the fluid supply 3; when the adjuster 30 moves to a delivering position, the through hole 31 communicates with the second channel 12 and a fluid supply 3, the first channel 11 is incommunicable with the fluid supply 3.

In this embodiment, the pipe 20 further includes a second conduit 21 provided for being connected with the fluid supply 3. The second conduit 21 is separated from the first conduit 22. When the adjuster 30 moves to the inflating position, the through hole 31 communicates with the first channel 11 and the second conduit 21; when the adjuster 30 moves to the delivering position, the through hole 31 communicates with the second channel 12 and the second conduit 21. Moreover, the first conduit 22 and the second conduit 21, which are separated, are integrally formed within the pipe 20. In other embodiment, the pipe can be further provided with a barrier to separate the first conduit and the second conduit.

To locate the adjuster 30 precisely, the adjuster 30 is provided with a clamping assembly 32 to be selectively clamped with a first clamping portion 141 or a second clamping portion 142 disposed on the inflatable bag structure 10 so that the adjuster 30 is selectively located at the inflating position or the delivering position.

When the adjuster 30 moves to the delivering position, the fluid flows through the second conduit 21, the through hole 31 and the first channel 11 to the inflated space 13 so that the inflated space 13 expands. When pressure of the fluid supply is removed, the fluid in the inflated space 13 flows reversely through the second conduit 21 to outside, and the inflated space 13 shrinks. In other embodiments, the inflatable bag structure can be further provided with a relief valve to discharge the fluid directly. When the adjuster 30 moves to the delivering position, the fluid flows through the second conduit 21, the through hole 31, the second channel 12 and the first conduit 22 to the tube 2.

In this embodiment, the inflatable bag structure 10 includes a first fixed portion 14, a second fixed portion 15 and a bag 16.

The first fixed portion 14 is disposed at an end of the inflatable bag structure 10 and surrounds the pipe 20. The adjuster 30 is movably inserted into the first fixed portion 14. The first fixed portion 14 includes the first channel 11 and the second channel 12. By moving the adjuster 30, the second conduit 21 selectively communicates with the first channel 11, the second channel 12, or neither.

The bag apparatus for delivering fluid 1 further includes a fastening member 17. The fastening member 17 is inserted into and locating the first fixed portion 14 and the pipe 20. A first annular blocking surface 210 facing the second fixed portion 15 is disposed around an outer surface of the pipe 20. A second annular blocking surface 33 facing the first annular blocking surface 210 is disposed inside the adjuster 30. The first and second annular blocking surfaces are blocked axially by each other. Therefore, the adjuster 30 is unable to move axially, relative to the first fixed portion 14.

The second fixed portion 15 is disposed at the other end of the inflatable bag structure 10 and surrounds the pipe 20. An end of the bag 16 is fixedly disposed around the first fixed portion 14, the other end of the bag 16 is fixedly disposed around the second fixed portion 15, and the inflated space 13 is formed between the bag 16 and the pipe 20. At least one rid 160 is further disposed around an outer surface of the bag 16 to enhance the structural strength of the bag. The at least one rid 160 also makes the bag 16 contact the tube 2 more tightly.

Two C-rings 23 are disposed outside the pipe 20, and the second fixed portion 15 is position-limited between two said C-rings. A distance of two said C-rings 23 is roughly equal to an axial length of the second fixed portion 15, so that the second fixed portion can not move when the bag expands. Understandably, the distance of two said C-rings can be longer than an axial length of the second fixed portion. In other embodiment, only one C-ring may be disposed around outside the pipe, the inflatable bag structure is position-limited between the adjuster and the C-ring. The first fixed portion 14 is closer to the second portion 15 when the bag expands, a degree of radial deformation of the bag increases, so that the bag can seal the tube 2 having a longer diameter.

The pipe 20 is provided with at least one check valve between the fluid supply 3 and the inflatable bag structure 10 so that the fluid flows from the fluid supply to the inflatable bag structure. In this embodiment, the pipe is provided with two check valves, wherein one said check valve 5 has a gas receiving end, and another check valve 4 connects to an inflating pump (fluid supply 3). Moreover, the pipe 20 is provided with an escape valve 6 between the fluid supply 3 and the inflatable bag structure 10 to discharge the fluid. In all above embodiments, the check valves and the escape valve may not be provided, because the second conduit 21 can be selectively communicable or incommunicable with the different fluid supply to deliver or discharge the fluid in different stages.

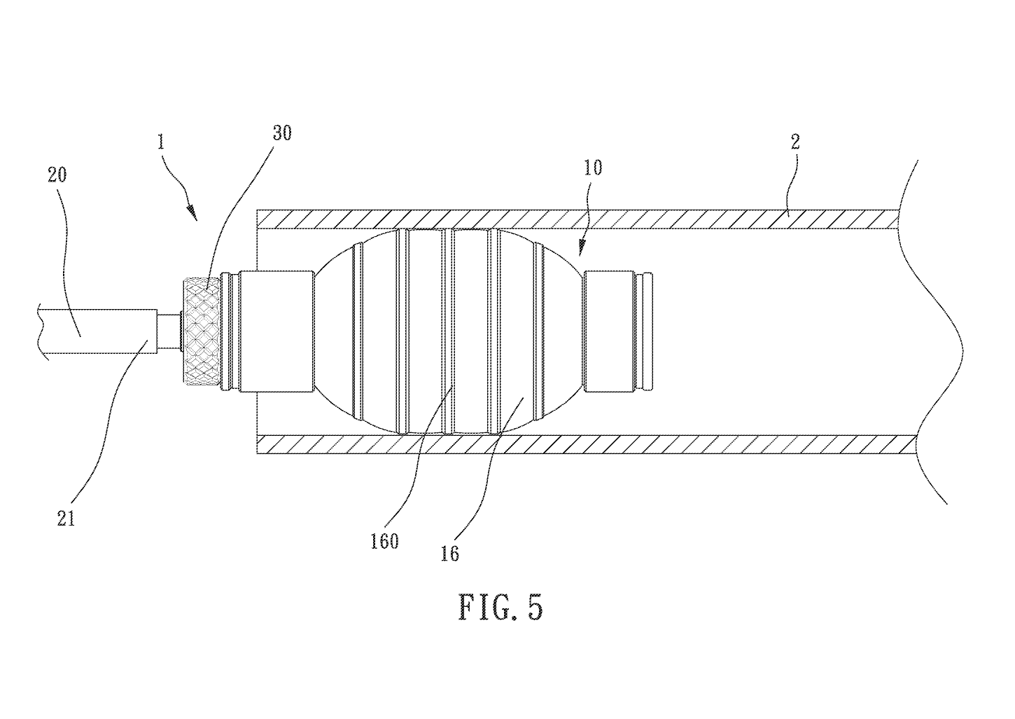

Referring to FIGS. 3, 3A and 5, at beginning of an inflating stage, the inflatable bag structure 10 is put into the tube 2 in advance, and the adjuster 30 is moved to the inflating position. Then, the inflating pump delivers a gas, the gas flows through the check valve 4, the second conduit 21, the through hole 31 and the first channel 11 to the inflated place 13 to expand the bag 16 until the bag seals the tube 2. In an alternative embodiment, the gas can be delivered from the check valve 5 to expand the bag.

Referring to FIGS. 4 and 4A, at beginning of a delivering stage, the adjuster 30 is moved to the delivering position, and the gas receiving end (check valve 5) is connected with a fluid supply. In this embodiment, the delivering fluid may be colored gas. The fluid supply delivers the colored gas, the colored gas flows through the gas receiving end (check valve 5), the second conduit 21, the through hole 31, the second channel 12 and the first conduit 22 to the tube 2. If there is a leak on the tube, the colored gas may be discharged from the leak. In other embodiment, the delivering fluid may be delivered from the check valve 4.

At end of the delivering stage, the adjuster 30 is moved to the inflating position, and the escape valve 6 is turned on. Then, the bag can shrink so that the inflatable bag structure 10 can be put out from the tube 2.

As a conclusion, flow direction of the fluid can be adjusted more conveniently through the adjuster, so that the fluid can flow selectively into the inflated space or the first conduit.

Besides, the whole apparatus is smaller than the previous art.

While we have shown and described various embodiments in accordance with the present invention, it should be clear to those skilled in the art that further embodiments may be made without departing from the scope of the present invention.

What is claimed is:

1. A bag apparatus for delivering fluid, which is provided for delivering a fluid to a tube, comprising:
an inflatable bag structure, including a first channel and a second channel;
a pipe, penetrating through the inflatable bag structure, the pipe including a first conduit, the first conduit communicating with an outside of the inflatable bag structure, an inflated space formed between the pipe and the inflatable bag structure, the inflated space communicating with the first channel, the first conduit communicating with the second channel;
an adjuster, movably inserted into an end of the inflatable bag structure, a through hole disposed on the radial side of the adjuster;
wherein when the adjuster moves to an inflating position, the through hole communicates with the first channel and the fluid supply, the second channel is incommunicable with the fluid supply, when the adjuster moves to a delivering position, the through hole communicates with the second channel and a fluid supply, the first channel is incommunicable with the fluid supply.

2. The bag apparatus for delivering fluid as claimed in claim 1, wherein the inflatable bag structure includes:
a first fixed portion, disposed at an end of the inflatable bag structure and surrounding the pipe, the adjuster movably inserted into the first fixed portion, the first fixed portion including the first channel and the second channel;
a second fixed portion, disposed at the other end of the inflatable bag structure and surrounding the pipe;
a bag, an end of the bag fixedly disposed around the first fixed portion, the other end of the bag fixedly disposed around the second fixed portion, the inflated space formed between the bag and the pipe.

3. The bag apparatus for delivering fluid as claimed in claim 2, and further including a fastening member, being inserted into and locating the first fixed portion and the pipe.

4. The bag apparatus for delivering fluid as claimed in claim 3, wherein a first annular blocking surface facing the second fixed portion is disposed around an outer surface of the pipe, a second annular blocking surface facing the first annular blocking surface is disposed inside the adjuster, the first and second annular blocking surfaces are blocked axially by each other.

5. The bag apparatus for delivering fluid as claimed in claim 2, wherein at least one rid is further disposed around an outer surface of the bag.

6. The bag apparatus for delivering fluid as claimed in claim 1, wherein a C-ring is disposed around outside the pipe, the inflatable bag structure is position-limited between the adjuster and the C-ring.

7. The bag apparatus for delivering fluid as claimed in claim 2, wherein two C-rings are disposed outside the pipe, and the second fixed portion is position-limited between two said C-rings.

8. The bag apparatus for delivering fluid as claimed in claim 7, wherein a distance of two said C-rings is longer than an axial length of the second fixed portion.

9. The bag apparatus for delivering fluid as claimed in claim 1, wherein the adjuster is provided with a clamping assembly to be selectively clamped with a first clamping portion or a second clamping portion disposed on the inflatable bag structure so that the adjuster is selectively located at the inflating position or the delivering position.

10. The bag apparatus for delivering fluid as claimed in claim 1, wherein the pipe is provided with at least one check valve between the fluid supply and the inflatable bag structure so that the fluid flows from the fluid supply to the inflatable bag structure.

11. The bag apparatus for delivering fluid as claimed in claim 1, wherein the pipe is provided with an escape valve between the fluid supply and the inflatable bag structure.

12. The bag apparatus for delivering fluid as claimed in claim 1, wherein the pipe further includes a second conduit provided for being connected with the fluid supply, the second conduit is separated from the first conduit, when the adjuster moves to the inflating position, the through hole communicates with the first channel and the second conduit, when the adjuster moves to the delivering position, the through hole communicates with the second channel and the second conduit.
